(19) United States
(12) Patent Application Publication
(10) Pub. No.: US 2014/0014490 A1
(43) Pub. Date: Jan. 16, 2014

(54) HEAT INTEGRATED DISTILLATION COLUMN USING STRUCTURED HEAT EXCHANGER

(71) Applicant: Odolphus Simon Leo Bruinsma, Petten (NL)

(72) Inventor: Odolphus Simon Leo Bruinsma, Petten (NL)

(73) Assignee: STICHTING ENERGIEONDERZOEK CENTRUM NEDERLAND, Petten (NL)

(21) Appl. No.: 13/980,309

(22) PCT Filed: Jan. 12, 2012
(86) PCT No.: PCT/NL2012/050017

§ 371 Date: Oct. 2, 2013

(30) Foreign Application Priority Data
Jan. 18, 2011 (NL) 2006023

(51) Int. Cl. B01D 3/00

(52) U.S. Cl. CPC B01D 3/007
USPC 202/154

(57) ABSTRACT

Heat integrated distillation column for separating components in a fluid mixture. The heat integrated distillation fluid column is provided with a stripper part (S), a rectifier part (R) and a compressor (2) between the stripper part (S) and the rectifier part (R). Furthermore, a heat exchange assembly for transferring heat between the stripper part (S) and the rectifier part (R), and a mass transfer assembly for condensation and vaporization in the heat integrated distillation column are provided. The stripper part (S), the rectifier part (R), or the stripper part (S) and rectifier part (R), comprise a channel assembly (6) which forms a structural part of the heat integrated distillation column and a functional part of the heat exchange assembly and of the mass transfer assembly.

### FIELD OF THE INVENTION

The present invention relates to a heat integrated distillation column for separating components in a fluid mixture, the heat integrated distillation column comprising a stripper part, a rectifier part and a compressor between the stripper part and the rectifier part, and a heat exchange assembly for transferring heat between the stripper part and the rectifier part, and a mass transfer assembly for condensation and vaporization in the heat integrated distillation column.

### PRIOR ART

International patent publication WO03/011418 discloses a heat integrated distillation column for stripping an rectifying a fluid mixture. The stripper section and rectifier section comprise multiple channels, wherein a channel for the stripper section and a channel for the rectifier section alternate. The channels are formed by a number of adjacent plates which provide the heat exchange function. Meandering fins are positioned inside the adjacent plates to allow condensate to form thereon in the rectifier section and to allow vapor to be formed in the stripper section, and to collect condensate at the bottom of the channels and the vapor at the top of the channels.

American patent publication U.S. Pat. No. 5,968,321 discloses a vapor compression distillation system. Heat transfer plates are welded together to form alternate boiling and condensing chambers. Structural strength is provided in the distillation system by outer walls and bolts. This is not a heat integrated distillation column as separation is not considered.

American patent publication U.S. Pat. No. 3,498,372 discloses a matrix made of superimposed plates which are each embossed with a regular pattern of pyramid-shaped projections with indentations. Plates with shallow and deeper projections are combined. This is not a heat integrated distillation column as separation is not considered.

British patent publication GB 2 035 831 discloses a filling material for mass and heat transfer applications. The material is shape-perforated material which can be assembled in parallel to form multi-layered packings. The basic shape is a pyramidal basic body 5. This is not a heat integrated distillation column as heat transfer between compartments is not considered.

### SUMMARY OF THE INVENTION

The present invention seeks to provide a more efficient heat integrated distillation column, especially with an improved mass transfer capacity.

According to the present invention, a heat integrated distillation column according to the preamble defined above is provided, wherein the stripper part, the rectifier part, or the stripper part and rectifier part, comprise two or more channel assemblies, each channel assembly forming a structural part of the heat integrated distillation column and a functional part of the heat exchange assembly and of the mass transfer assembly. The channel assemblies form the flow channels for the stripper part, rectifier part, or both. As the channel assembly is a structural part of the heat integrated distillation column (HIDiC), it is possible to easily and efficiently form an entire HIDiC, e.g. by a combination of a plurality of channel assemblies in parallel, or in sections on top of each other. The channel assembly also forms a functional part of both the heat exchange assembly and the mass transfer assembly at the same time, providing a more efficient build of the HIDiC. These separate elements forming the actual channels for the stripper part, rectifier part, or both, can be easily assembled. Also, the internal components of the heat integrated distillation column, comprising loose elements, can easily be replaced by other types of internal components, e.g. in order to revamp the heat integrated distillation column, making the present invention embodiments more flexible than prior art systems.

A thickness of a channel assembly perpendicular to a longitudinal direction of the heat integrated distillation column is between 1 and 5 cm in a further embodiment, e.g. 2 cm. This is different from many prior art applications, where dimensions in this direction are limited to the mm range. According to these invention embodiments, a better combination of characteristics is achieved in the area of heat transfer and mass transport.

In an embodiment, the channel assembly comprises components made of a heat transfer material, such as metal (e.g. steel), one of the components being a channel part being formed to allow condensation on the surface of the material or to allow vaporization from the surface of the material. This material can thus be used for both functions of the HIDiC.

The channel assembly has a density or weight of less than 1500 kg/m³, e.g. less than 1000 kg/m³ in a further embodiment.

In a further group of embodiments, the channel assembly comprises an embossed plate assembly, the embossed plate assembly comprising two plates which are connected to each other at spots in a regular pattern, an internal space being present between the two plates with a varying distance between the two plates. In a further embodiment, the internal space forms a first channel, and an external space between two adjacent embossed plate assemblies forms a second channel. The embossed plate assembly may be a single embossed plate assembly of which one plate is flat over its entire surface, or alternatively, a double embossed plate assembly of which both plates have an irregular formed surface.

In an even further group of embodiments, the channel assembly comprises a corrugated plate having a corrugation direction formed by parallel tops and valleys, wherein the corrugation direction is perpendicular to a longitudinal direction of the heat integrated distillation column. This provides a very open structure of channels in the HIDiC, resulting in a very low pressure drop.

Multiple channel assemblies are provided positioned in parallel along a longitudinal direction of the heat integrated distillation column in a further embodiment, in order to provide a higher capacity for processing.

In a further embodiment, one of the stripper part and rectifier part comprises a plurality of (e.g. cylindrical) channel assemblies positioned concentrically, the space between the plurality of cylindrical channel assemblies forming the other one of the stripper part and rectifier part. Cylindrical embodiments of processing plant components are regularly used, and provide a more uniform processing environment across the channels formed.

The heat integrated distillation column in a further embodiment comprises an envelope housing surrounding the rectifier part and stripper part. In both rectangular and circular cross section embodiments, this allows to properly seal off the stripper and rectifier part from the environment.

### SHORT DESCRIPTION OF DRAWINGS

The present invention will be discussed in more detail below, using a number of exemplary embodiments, with reference to the attached drawings, in which

FIG. 1 shows a schematic diagram of a heat integrated distillation column;

FIG. 2 shows a perspective view of a channel assembly according to an embodiment of the present invention;

FIG. 3 shows a perspective view of a channel assembly according to an alternative embodiment of the channel assembly of FIG. 2;

FIG. 4 shows a combination of multiple channel assemblies of FIG. 2 to form channels of a HIDiC;

FIG. 5 shows an alternative combination of multiple channel assemblies of FIG. 2 to form channels of a HIDiC, and

FIG. 6 shows a sectional view of multiple channels formed by a further embodiment of the channel assembly.

### DETAILED DESCRIPTION OF EXEMPLARY EMBODIMENTS

Over the years a number of distillation energy saving technologies have been developed. In conventional distillation columns the energy supplied to a reboiler and extracted in a condenser is lost. In a vapor recompression column (VRC), introduced in the 1980's, a compressor is used as a heat pump to raise the temperature of the top vapor such that it can be used as heating medium for the reboiler. Energy savings are 50-80%, but the maximum temperature lift is economically limited to 30° C., or to about 15% of the installed distillation columns of interest.

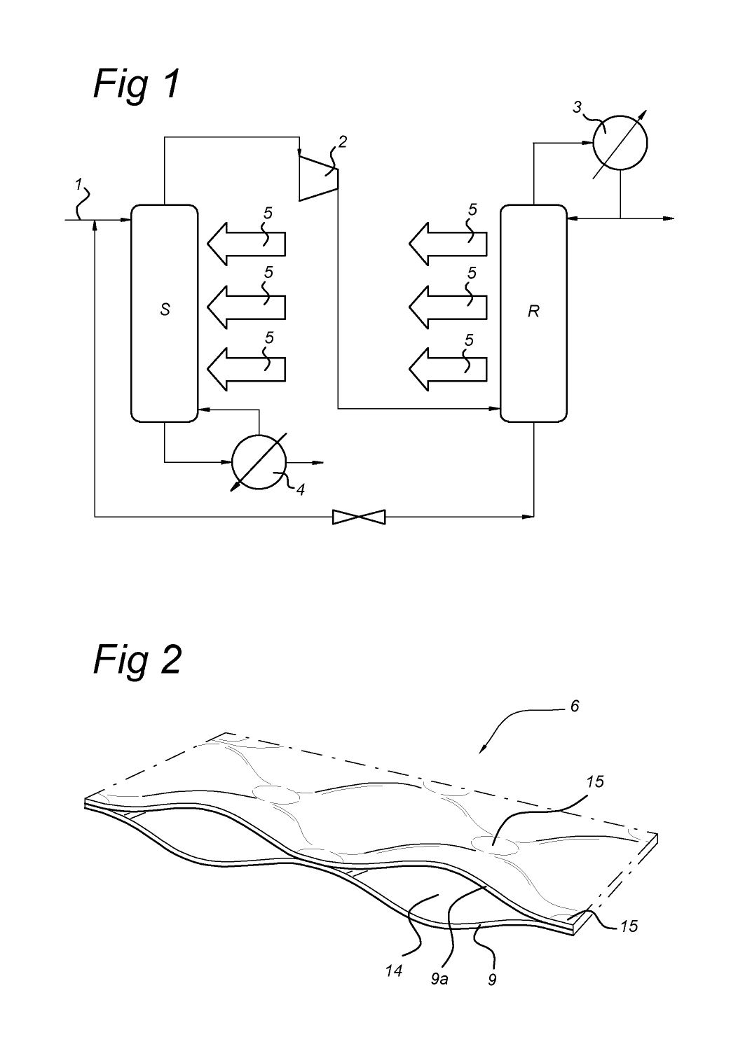

A method for separating two components in a fluid is shown diagrammatically in FIG. 1. A mixture (fluid) to be separated is fed to a stripper part S at 1. A gaseous product is fed via a line to a compressor 2 and fed to a rectifier part R. The liquid product (condensate) produced in this rectifier part R is returned to line 1. Vapor from the top of the rectifier part R is fed to an external condenser 3. Liquid that is produced in stripper part S (condensate) is fed from an outlet at the bottom to a reboiler 4, and then partially discharged as a bottom (output) product. The heat transfer from the rectifier part R to the stripper part S is indicated by the arrows 5. It will be understood that it is important to allow this heat transfer to take place as efficiently as possible. According to the present invention embodiments this is achieved by direct heat transfer between the stripper part S and rectifier part R. A system employing such a separation method is also known in the field as a heat integrated distillation column (HIDiC).

In a heat integrated distillation column (HIDiC) the temperature rise over the compressor is only half the value of the temperature difference over the distillation column; thus the compressor power for a HIDiC is typically 50% of that for the VRC. Conventional so-called concentric tray HIDiC columns (see e.g. US patent publication U.S. Pat. No. B-7,678,237) have complex and expensive internals and therefore are economically only superior to the VRC in the temperature lift range 20-45° C. These columns are generally limited by heat transfer.

Also a plate-fin configuration (PF-HIDiC) of a heat integrated distillation column is known, as e.g. described in international publication WO03/011418. This type of HIDiC has a number of drawbacks, including but not limited to:
PF-HIDiC's do not have good separation properties as a consequence of the straight and open channels that result in a low liquid holdup and a high sensitivity to maldistribution;
PF-HIDiC's have thousands of parallel channels that require a major effort for the distributors;
A PF-HIDiC is heavy and therefore expensive;
PF-HIDiC's are difficult to manufacture and can only be made in smaller modules, which do not have the required capacity for bulk distillation processes;
Most PF-HIDiC's are made of aluminium, a material that is incompatible with many distillation columns.

The present invention embodiments, as described below, relate to a heat integrated distillation column (HIDiC) acting as a micro-structured separator which combines efficient heat transfer properties of known heat exchange implementations and efficient mass transfer (separation) properties associated with structured packing.

In an embodiment of the present invention, a heat integrated distillation column (HIDiC) is provided for separating components in a fluid mixture. The HIDiC comprises, as shown in the schematic view of FIG. 1, a stripper part S, a rectifier part R and a compressor 2 between the stripper part S and the rectifier part R. A heat exchange assembly is provided for transferring heat between the stripper part S and the rectifier part R, indicated by the arrows 5 in FIG. 1. The stripper part S, the rectifier part R or both the stripper part S and rectifier part R, comprise a channel assembly 6. The channel assembly 6 forms a structural part of the heat integrated distillation column and a functional part of the heat exchange assembly and of a mass transfer assembly which allows formation of vapor in the stripper part S, and condensate in the rectifier part R.

In other words the channel assembly 6 takes the form of a structural element for the entire HIDiC, e.g. by providing a separation between the stripper part S and rectifier part R, and at the same time also performs various functions in the HIDiC including a heat transfer function and mass transfer function.

By combining such structural and functional parts in the channel assembly 6, a more energy efficient and cost efficient HIDiC can be provided.

The HIDiC is furthermore provided with collectors, distributors, input/output connectors, valves and the like in order to obtain the fluid mixture flow as discussed with reference to FIG. 1.

In one embodiment, the channel assembly 6 comprises components made of a heat transfer material, such as a metal material, one of the components being a channel part being formed to allow condensation on the surface of the material and/or vaporization from the surface of the material, depending on which part of the HIDiC the channel assembly 6 is present. Thus, the channel assembly 6 provides both the functionality of heat transfer (arrows 5 in FIG. 1) and of mass separation in the HIDiC. The use of e.g. steel as material provides additional benefits as e.g. aluminum which is often used in PF-HIDiC systems, as steel is in most cases better withstanding the substances in the HIDiC in operation.

In a further embodiment, the channel assembly 6 has a density or weight of less than 1500 kg/m³, e.g. less than 1000 kg/m³, i.e. much less than a known plate-fin type HIDiC which has a density in the order of 2000-4000 kg/m³.

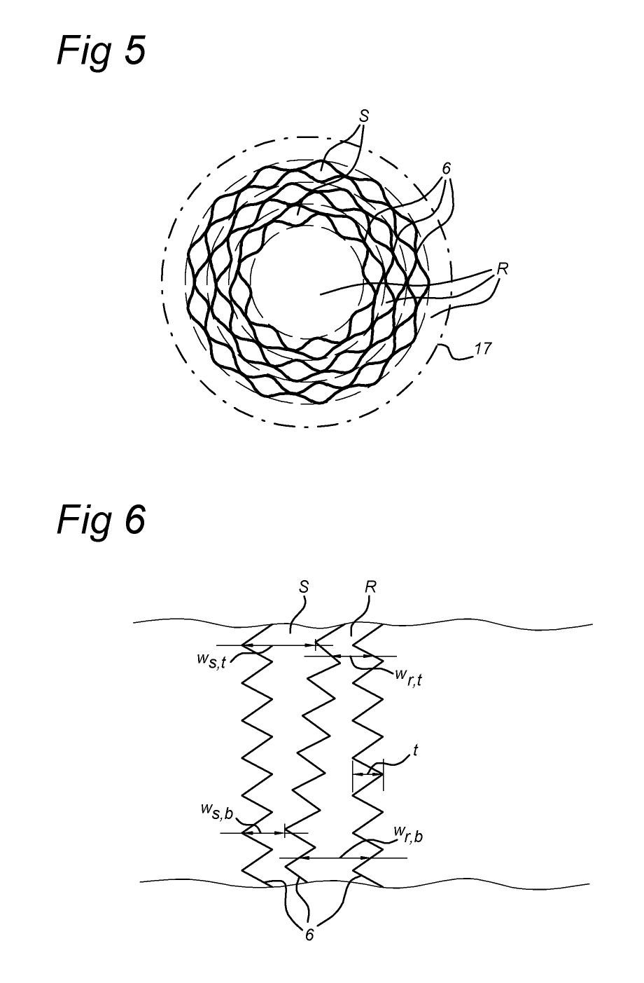

In a further group of embodiments, the channel assembly 6 comprises an embossed plate assembly, the embossed plate assembly comprising two plates 9, 9a which are connected to each other (e.g. laser welded) at spots 15 in a regular pattern. Two embodiments of this group of embodiments are shown in the perspective and partial cross sectional views of FIGS. 5 and 6. An internal space 14 is present between the two plates 9, 9a with a varying distance between the two plates 9, 9a. In the embodiments shown, the regular pattern of spots 15 is a two dimensional pattern of which lines connecting the weld spots 15 are at an angle to a longitudinal direction of the channel assembly 6 (e.g. at 45°). The resulting meandering internal space 14 with varying width is particularly suited as condensation or vaporization surface in the HIDiC.

In the embodiment shown in FIG. 2, the embossed plate assembly 6 is a double embossed plate assembly of which both plates 9, 9a have an irregular surface. This embodiment has the advantage that a larger internal surface area is formed in the channel 14.

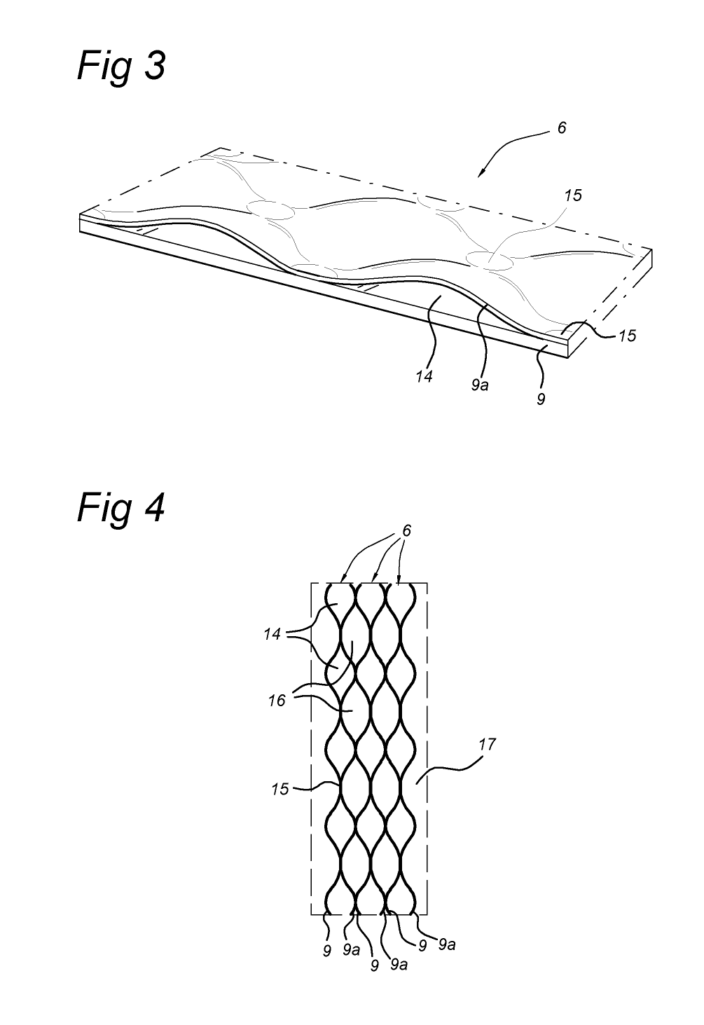

In the embodiment shown in FIG. 3, the embossed plate assembly 6 is a single embossed plate assembly of which one plate 9 is flat over its entire surface.

The embossed plate or plate-pillow embodiments as described here combine the excellent heat transfer characteristics of a compact heat exchanger and the separation performance of a three dimensional structure with excellent falling film features. This is a further improvement of heat integrated distillation technology leading to a reduction in column size and operating cost. Manufacturing limits of other structured HIDiC embodiments such as plate-fin or plate-packing embodiments are solved by these embodiments. Compared to plate-packing embodiments, the embossed plate or plate-pillow embodiment provides a better lateral strength allowing to better resist possible pressure differences between stripper and rectifier channels. Furthermore, an embossed plate or plate-pillow embodiment is easier to manufacture than a plate-packing variant of a HIDiC.

In FIG. 4, a cross sectional view is shown of an embodiment having a combination of multiple channel assemblies 6 using the double embossed plates as shown in FIG. 2. Multiple channel assemblies 6, each having an internal space 14 (comprising meandering channels) are put in parallel, thereby forming an external space 16 between two adjacent channel assemblies 6. The internal space may e.g. form a first channel 14 (e.g. of the stripper part S), and an external space between two adjacent embossed plate assemblies 6 then forms a second channel 16 (e.g. of the rectifier part R).

In the embodiment shown in FIG. 4, the channel assemblies 6 are positioned inside an envelope housing 17, which provides a sufficient sealing of the stripper and rectifier channels in the HIDiC.

In the embodiment shown in FIG. 4, tops and valleys of the embossed plates 9, 9a are aligned, as a result of which a regular pattern is formed. The embossed plates 9, 9a are as an alternative not precisely aligned. A more irregular pattern in a cross sectional view similar to FIG. 4 may then result. Furthermore, adjacent combinations of embossed plates 9, 9a are not connected to each other, they may be stacked separately in the heat integrated distillation column.

The envelope housing 17 in the embodiment shown is rectangular, but it may also be provided in a circular or other shape. The circular shape will have the advantage that the process conditions may be better controlled.

For all embodiments of the channel assembly 6 as described above, it is possible to form channels for the stripper part S, rectifier part R or both. Multiple channel assemblies 6 are provided in a further embodiment, positioned in parallel along a longitudinal direction of the heat integrated distillation column (similar to the embossed plate embodiment shown in FIG. 4). This increases the capacity of the HIDiC to a desired level for a specific application. Also, scaling up from a laboratory test version to a full scale production version of the HIDiC is easily achieved.

In a further embodiment, adjacent ones of the multiple channel assemblies 6 are mirrored, thereby forming the desired pattern of channels for either the stripper part S, rectifier part R, or both.

In an alternative embodiment of the HIDiC, shown in the cross sectional view of FIG. 5, the channel assemblies 6 are used to form concentric annular channel patterns. The HIDiC in this embodiment optionally comprises an envelope housing 17 (indicated by a dash dot line, e.g. in the form of a barrel or drum) surrounding the rectifier part R and stripper part S, the stripper part S comprising a plurality of cylindrically formed channel assemblies 6 positioned concentrically inside the envelope housing 17, and the rectifier part R being formed by the space between the plurality of cylindrical channel assemblies 6.

In the HIDiC, the composition of the fluid mixture flowing in the stripper part S and rectifier part R changes in the flow direction. To accommodate the changes in vapour content specifically, the cross sectional area of both the stripper part S and rectifier part R changes along the flow direction of the fluid mixture. In other words, the width of the multiple channel assemblies 6 varies along the longitudinal direction of the heat integrated distillation column. E.g. the HIDiC comprises a stripper part S and a rectifier part R with a gradual or stepwise increase and decrease, respectively in width between the heat exchanger plates. When using a stepwise increase/decrease, the HIDiC can be composed of several stages of the (combinations of) channel assemblies 6 as described with reference to the embodiments above.

This is shown in the embodiment as shown in FIG. 6, wherein adjacent channels of the stripper part S and rectifier part R are shown. The width of the stripper part channel increases from a bottom part value w_{S,B} to a top part value w_{S,T}. The width of the rectifier part channel decreases from a bottom part value w_{R,B} to a top part value w_{R,T}.

Also shown in the embodiment of FIG. 6 is the thickness t of the irregular surface of the channel assembly 6, in this case the height of corrugations in the plate. In more general terms, a thickness t of a channel assembly 6 perpendicular to a longitudinal direction of the heat integrated distillation column (i.e. the flow direction of fluids) is between 1 and 5 cm, e.g. 2 cm. This provides for a very efficient heat transfer capability, as well as a good mass transfer capability.

In the embodiment of FIG. 6 the channels are formed using a further embodiment of the channel assembly 6 in the form of a corrugated plate, wherein the corrugation direction is perpendicular to a longitudinal direction of the HIDiC. When made of the correct material for a suitable process, the liquid product will adhere to the surfaces of the channel assemblies 6 (wetting), the curves of the material providing efficient heat transfer between the stripper part S and rectifier part R. The channels provided in this manner are also open structured, as a result of which only a very low pressure drop will occur. The corrugations may have varying shape (Z-shape, wave shape, symmetrical or asymmetrical, etc.). Also using this embodiment of the channel assembly 6, rectangular channels may be formed, or circular channels, similar to the other embodiments described above.

Each channel assembly 6 (or combination of channel assemblies 6) described with reference to the embodiments described above, may form a single processing layer. The entire HIDiC may comprise many of such processing layers parallel to each other. Also dimensions of each processing layer may be increased for scaling up the HIDiC. E.g. in a test environment, the processing layer may be 1 meter high and 20 cm wide and a pillow-plate distance of 15 mm, providing a capacity of 50 kg/h and a heat transfer capacity of 5 kW. An industrial application may have a capacity 1000 times as high, e.g. by providing 100 processing layers of 200 cm wide with the same pillow-plate distance of 15 mm. To obtain a good separation, a total height of e.g. 5-10 meters is chosen, where the stripper part S has a decreasing cross section in the upward direction and the rectifier part R a decreasing cross section in the downward direction (providing a column with a constant diameter). The heat transfer capacity will then be in the order of 5-10 MW.

The embodiments described above will provide a type of HIDiC which may be called a structured HIDiC (S-HIDiC). The S-HIDiC combines the excellent heat transfer characteristics of a plate-fin heat exchanger and the distribution performance of structured packing. This is a further improvement of heat integrated distillation technology leading to a reduction in column size and operating cost. It solves the limited distribution properties of the plate-fin HIDiC, simplifies the design of the distributors and collectors at the ends of the HIDiC, and is more easily manufactured at the size required for industrial scale distillation.

The S-HIDiC as described with reference to the invention embodiments discussed above is a micro-structured separator that combines the efficient heat transfer properties of a plate-fin heat exchanger and the efficient mass transfer (separation) properties associated with structured packing. In contrast to the plate-fin HIDiC, where the focus is on heat exchange performance, in the S-HIDiC the focus is on separation (mass transfer), which is a performance limiting factor, as was shown experimentally.

The channel assembly 6 in the S-HIDiC is responsible for heat transfer, separation, and low pressure drop and should be able to handle vapor velocities corresponding with F-factors in the order of 1-3 Pa^{1/2} and have an acceptable turndown ratio of 2. The good separation and (re)distribution performance, associated with the channel assembly 6 in the S-HIDiC, results in a better performance in comparison to the PF-HIDiC and thus to a further reduction in column height.

The low cost S-HIDiC with its high specific heat transfer area and low pressure drop, leads to lower minimum approach temperatures and thus to further energy savings and expanding the temperature application range. In a case study it was shown that compared to tray HIDiC's (see e.g. U.S. Pat. No. 7,678,237) the pressure drop is substantially lower, which results in lower compressor power, which is especially beneficial for vacuum distillation process such as ethylbenzene/styrene.

It is anticipated that the S-HIDiC will not only outperform the concentric tray HIDiC in its application range, but that 60-75% energy savings will become possible in the 20-60° C. temperature lift range

The minimum specific targets for the S-HIDiC are:
HETP=0.3 m (separation);
optimum F-factor=2 Pa^{0.5} (capacity);
heat transfer=200 W/m²/K;
pressure drop=1 mbar/stage;
turndown ratio=2 (flexibility);
investment cost comparable to conventional structured packing column.

The S-HIDiC according to the present invention embodiments leads to 60-75% energy savings for columns with a temperature lift of 20-60° C. The S-HIDiC has an improved separation efficiency compared to the plate-fin HIDiC leading to shorter columns and thus investment cost. In addition pressure drop goes down leading to lower compression cost. The S-HIDiC in comparison with the concentric tray HIDiC leads to smaller equipment and less complicated internals. The resulting reduction in total separation cost extends the economic application range to temperature lifts of 20-60° C.

A HIDiC according to the present invention embodiments is used, for example, as part of a complete process for several substances. E.g. it may be used for separating hydrocarbons having boiling points which are close to one another. Also other substances may be processed as mentioned in the following list, where a S-HIDiC embodiment may be applied multiple times in the entire process: MDI (diphenyl methane diisocyanate); Ethylene oxide; Phtalic anhydride; Butene-1; Cyclohexanone; Isopropanol; Oxo-alcohols; Butadiene; Propylene oxide/styrene (PO/SM); Caprolactam; Alkylation (Refinery); Benzene; Bisphenol-A; Styrene; Propylene oxide/t-butyl alc. (PO/TBA); Gasoline/pygas hydrogenation.

An additional application is in the distillation of ethanol for bio-fuels. The present invention embodiments have been described above with reference to a number of exemplary embodiments as shown in the drawings. Modifications and alternative implementations of some parts or elements are possible, and are included in the scope of protection as defined in the appended claims.

1-11. (canceled)

12. A heat integrated distillation column for separating components in a fluid mixture, the heat integrated distillation column comprising:
(a) a stripper part, a rectifier part and a compressor between the stripper part and the rectifier part.
(b) a heat exchange assembly for transferring heat between the stripper part and the rectifier part, and
(c) a mass transfer assembly for condensation and vaporization in the heat integrated distillation column,
wherein the stripper part, the rectifier part, or the stripper part and rectifier part, comprise two or more channel assemblies, each channel assembly forming a structural part of the heat integrated distillation column and a functional part of the heat exchange assembly and of the mass transfer assembly,
wherein the channel assembly comprises an embossed plate assembly, the embossed plate assembly comprising two plates which are connected to each other at spots in a regular pattern, an internal space being present between the two plates with a varying distance between the two plates.

13. The heat integrated distillation column of claim 12, wherein a thickness of a channel assembly perpendicular to a longitudinal direction of the heat integrated distillation column is between 1 and 5 cm.

14. The heat integrated distillation column of claim 12, wherein the channel assembly comprises components comprising a heat transfer material, one of the components being a channel part being formed to allow condensation on the surface of the material or to allow vaporization from the surface of the material.

15. The heat integrated distillation column of claim 12, wherein the channel assembly has a weight of less than 1500 kg/m³.

16. The heat integrated distillation column of claim 12, wherein the internal space forms a first channel, and an external space between two adjacent embossed plate assemblies forms a second channel.

17. The heat integrated distillation column of claim 12, wherein the embossed plate assembly is a double embossed plate assembly of which both plates have an irregular formed surface.

18. The heat integrated distillation column of claim 12, wherein the embossed plate assembly is a single embossed plate assembly of which one plate is flat over its entire surface.

19. The heat integrated distillation column of claim 12, comprising multiple channel assemblies positioned in parallel along a longitudinal direction of the heat integrated distillation column.

20. The heat integrated distillation column of claim 19, further comprising an envelope housing surrounding the rectifier part and stripper part.

21. The heat integrated distillation column of claim 19, wherein the width of the multiple channel assemblies varies along the longitudinal direction of the heat integrated distillation column.

22. The heat integrated distillation column of claim 12, wherein one of the stripper part and rectifier part comprises a plurality of channel assemblies positioned concentrically, the space between the plurality of cylindrical channel assemblies forming the other one of the stripper part and rectifier part.

23. The heat integrated distillation column of claim 22, further comprising an envelope housing surrounding the rectifier part and stripper part.

24. The heat integrated distillation column of claim 22, wherein the width of the multiple channel assemblies varies along the longitudinal direction of the heat integrated distillation column.
